(19) United States
(12) Patent Application Publication
(10) Pub. No.: US 2005/0154755 A1
(43) Pub. Date: Jul. 14, 2005

(54) Classification of media files based on symbols

(76) Inventors: Chand Malu, Vantaa (FI); Murali Punaganti, Vantaa (FI); Petteri Saarinen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/516,283

(22) PCT Filed: May 28, 2003
(86) PCT No.: PCT/FI03/00421

(51) Int. Cl. G06F 7/00

(52) U.S. Cl. 707/104.1

(57) ABSTRACT

A technique for storing and selecting media files, such as digital images, video clips or music files, on the basis of symbols (S). The symbols comprise an identifier (11, 422) and visual data (428, 438, 448). For each media file (400) there is association data (402) for associating user-selected symbols (420, 430, 440) with the media file. The association data (402) comprises an identifier (404) of the media file and an identifier (408-412) of each associated symbol. For example, a photograph of a camel family in the New York zoo can be associated with the symbols for camel (420), family (430) and New York (440). The invention simplifies media file classification and retrieval in portable user devices without a full alphanumeric keyboard. The user may obtain more symbols from an external source, such as a dedicated symbol server.

### BACKGROUND OF THE INVENTION

The invention relates to classification of media files on the basis on symbols. As used herein, ‘media files’ means pictures, video clips, films, sound and other types of storage data that cannot be adequately described by words alone. A ‘file’ means a collection of stored data that can be addressed by an identifier, such as a file name. A file has a finite size and, accordingly, a stored video clip is a media file whereas a received broadcast transmission is not. Further examples of media files are digitally stored photographs or pieces of music. In order to provide a concrete example, the invention will be described in the context of digital images, but it should be noted that the invention is applicable to other types of media files. Thus the term ‘media’ should be interpreted as any component or component collection of multimedia, and the invention is mainly related to files that are not easily searchable by text-based searches.

Photographs are traditionally archived on the basis of a combination of a film number (or other identifier) plus picture number within the film. Digitally stored photographs are generally identified by using the file name conventions of the underlying computer platform. In such archiving systems, the only way to locate pictures relating to certain subjects is to search sequentially through the entire picture archive. Every picture file must be opened and the picture must be viewed to check if it contains desired subject matter.

Commercially available programs for storing media files support metadata, such as keywords associated with a picture such that the keywords describe the content of a picture. The metadata approach has the benefit that a picture can be found by a suitable combination of keywords.

A problem associated with the above-described metadata approach is that hand-held devices, such as mobile terminals, have small keyboards and displays that do not readily lend themselves to entering or displaying multiple keywords.

Graphical user interfaces rely on symbols to conserve screen space. A well-designed symbol, such as a printer icon, is intuitively associated with a printing function. But a problem with symbols is that they work well in closed systems, that is, in systems with well-defined symbols collections that can be defined in the documentation of that user interface (typically within an application program for computers). Symbols do not work well in open systems in which the symbols are not predefined. Given the small amount of resources in a handheld device, many pictures cannot be properly classified by means of symbols installed in the device. A similar problem is encountered when media files need to be searched in a hand-held device that does not have a complete keyword.

### BRIEF DESCRIPTION OF THE INVENTION

An object of the present invention is to provide methods and equipment for implementing the method so as to alleviate the above disadvantages. In other words, the object of the invention is to create methods and equipment for classifying and searching media files in a device with small user interface. The object of the invention is achieved by methods and equipment which are characterized by what is stated in the attached independent claims. The dependent claims disclose preferred embodiments of the invention.

The invention is based on using symbols to classify and search the media files. An aspect of the invention is a method and apparatus for storing media files. For instance, the invention can be used in an apparatus with an attached still or video camera. Or, the invention may be used with a music player or recorder with a suitable display for displaying the symbols associated with the media files (pieces of music in this case).

One or more symbols are associated with each media file. Each symbol comprises at least a symbol identifier and visual data. The visual data of at least a subset of the symbols are displayed to a user via a user interface. The user selects one or more symbols. The user-selected symbols are associated with the media file. The process (user selection, and symbol display, if necessary) is repeated until the user is satisfied with the set of symbols associated with the media file.

The association of a media file and one or more symbols can be accomplished by maintaining an association data table linking the identifier of the media file and the identifiers of the symbols associated with that media file. The association data table is preferably stored in the same physical memory with the media file in question. For instance, the physical memory may be a detachable memory card in a digital camera or a pocket computer attached to a camera. If the media files and the related association data are saved in the same detachable memory card, the association is maintained if the memory card is detached from the camera. It suffices to store only the identifier of each associated symbol. The memory-consuming visual data need not be stored in the memory card.

Typically, each symbol corresponds to one word or similar semantic entity. This is not an absolute requirement, however. By virtue of the symbol identifiers, the symbols are not tied to a specific human language, and some words in one language translate to multiple words in another. But we can say that each of a large majority of the symbols corresponds to one word.

It should also be noted that the user uses graphic symbols (visual data) to select query parameters. After the query parameters are selected, the visual data itself is no longer needed in the query, but only the symbol identifiers. This is because the search mechanism does not search for an arbitrary graphic image but recognizes well-defined and system-wide symbol identifiers.

The visual data is intended for an iconic representation of a symbol. This means that the bitmap size (in a bitmap) or level of detail (in a vector format) should be so small that resource consumption is minimized, but not so small that symbols cannot be recognized reliably, given the size and resolution of typical displays.

Another aspect of the invention is a method and apparatus for selecting stored media files based on symbols. The apparatus stores several media files and several symbols. Each symbol comprises at least a symbol identifier and visual data. The apparatus also stores an association of each of the several media files with one or more symbol identifiers. A user selects symbols. The selection of symbols comprises:
(a) presenting the visual data of a symbol to the user;
(b) in response to the user selecting the symbol, adding the symbol identifier of the symbol to a set of query parameters;
(c) repeating the two previous steps until termination by the user;
Then a query is formed on the basis of the set of query parameters and the several media files are queried for media files that match the query.

Preferably, each symbol also comprises a plaintext description that can be selectively shown to remind a user as to what the symbol means. Also, the plaintext description can be used to obtain more symbols from external sources.

According to another preferred embodiment of the invention, the user may obtain more symbols from an external source. For instance, the apparatus may be a mobile telephone, and the user may download symbols from an external symbol server via an access and/or data network. To ensure consistency of symbols between different users and different networks, the symbol server is preferably part of a network-wide or global hierarchy of symbol servers in which a symbol server consults another server, such as a top-level server, if it does not have a requested symbol. The symbol server may send a billing centre a charging data record indicating the number, price and/or type of symbols transferred to the apparatus, whereby the billing centre can charge the subscriber of the apparatus for the transferred symbols. Thus a network operator or the symbol server operator may charge the subscriber for downloaded symbols.

Alternatively, more symbols can be obtained from suitably programmed memory cards or from other user devices, such as personal computers, via a suitable data interface.

### BRIEF DESCRIPTION OF THE DRAWINGS

In the following the invention will be described in greater detail by means of preferred embodiments with reference to the attached drawings, in which

FIG. 1 is a schematic illustration of a symbol;

FIG. 2 illustrates a symbol in a mark-up language;

FIG. 3 illustrates a user interface for selecting symbols and an optional symbol hierarchy;

FIG. 4 is a block diagram illustrating memory organization in a storage device;

FIG. 5 is a flowchart illustrating a user interface logic related to symbols;

FIG. 6 shows a network arrangement suitable for downloading symbols from a dedicated symbol server;

FIG. 7 shows a signalling diagram for downloading symbols from a network arrangement as shown in FIG. 6;

FIG. 8 shows a flowchart for selecting media files based on symbols;

FIG. 9 shows some optional features of an advanced user interface.

### DETAILED DESCRIPTION OF PREFERRED EMBODIMENTS OF THE INVENTION

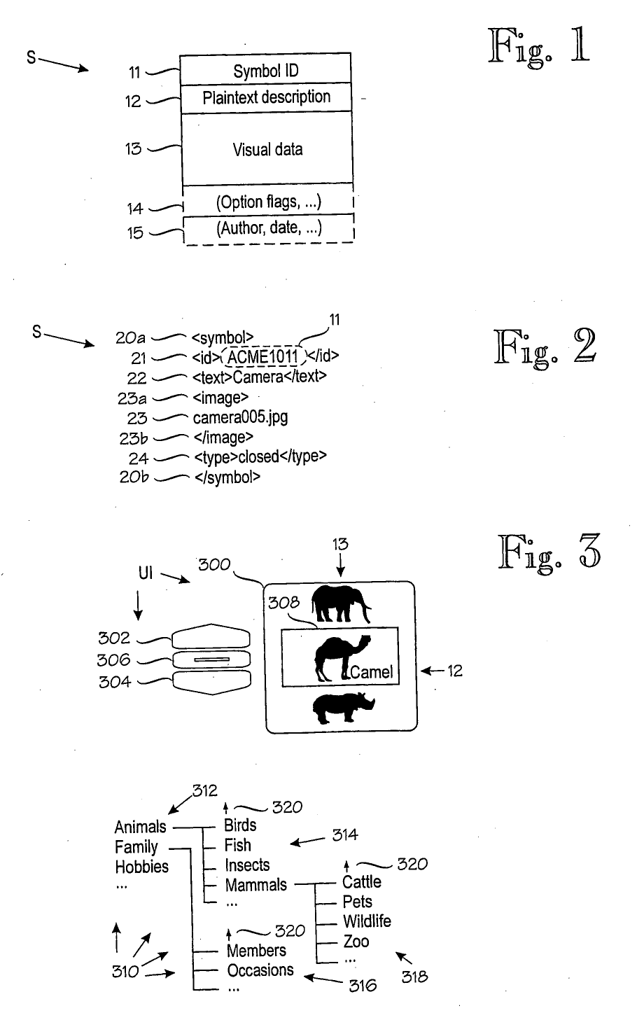

In the attached Figures, the first digit of a reference numeral indicates the Figure in which the corresponding item is first described. For instance, item 11 is first described in FIG. 1.

FIG. 1 is a schematic illustration of a symbol, generally denoted by reference sign S. The essential components of the symbols S are symbol identifier 11 and visual data 13. The symbol identifier 11 will be used to create the association with the identifiers of the media files. The visual data 13 is used to visually present the symbols in a user interface. The visual data 13 can be incorporated in the symbol S itself, or it can be a reference, such as an filename (and an optional directory path) to a separate image file. For example, the visual data 13 may be in a scalable vector graphics (SVG) format, or it may be a bitmap. An advantage of the scalable vector graphics format is that the symbol is better viewable in devices having different resolutions.

The visual data is not a piece of art per se and is only intended for an iconic representation of a symbol. Thus the level of detail should be dimensioned such that symbols can be reliably distinguished but resource consumption is minimized. Given a display resolution of a few hundred or a thousand pixels in each direction, the visual data should not exceed 100 pixels in either direction, and 32 by 32 pixels, or the equivalent amount of detail in a vector representation, can be considered a reasonable size. Note that a large number of different symbols requires a detailed iconic representation in order to make the symbols distinguishable.

Preferably, the symbol S also comprises a plaintext description 12. The plaintext description can be selectively shown to remind a user as to what the symbol means. Also, the plaintext description can be used to obtain more symbols from external sources, as will be described later.

The symbol S may also comprise an optional field 14 for indicating certain optional settings, commonly called flags. For example, there may be a flag that indicates whether the symbol can be modified by the user. If there is an option for preventing users from modifying symbols, the symbol must also comprise some integrity checking, such as checksums or hash codes, as is well known to persons skilled in cryptography. Further, the programs for checking the integrity must be executed in protected memory.

The symbol S may also comprise an optional field 15 for indicating authorship, source, creation date, version, etc. It is envisioned that telecommunication network operators will be able to charge small amounts of money for symbols downloaded from their networks, and such authorship indicators will be useful. As regards this invention, however, the field 15 is not essential.

FIG. 2 illustrates a symbol S in a mark-up language, such as XML (extendible mark-up language). The symbol shown in FIG. 2 is self-explanatory to a person with some knowledge in XML. Rows 20a and 20b delineate the symbol. Row 21 comprises the symbol identifier 11. Row 22 comprises the plaintext description. Rows 23a and 23b delineate the visual data 23 which in this example is a filename of “camera005.jpg”. Alternatively, the visual data 23 may be comprised as inline code within the symbol S. A benefit of the embodiment shown in FIG. 2, in which the visual data 23 is a reference to an external image file, is that the symbols S are very small and can be stored in multiple places of a symbol hierarchy without consuming too much memory.

FIG. 3 illustrates a user interface UI for selecting symbols and an optional symbol hierarchy. In this example, the user interface UI is very primitive and comprises only three selector keys in addition to a small display 300. The keys are an up key 302, a down key 304 and selector (“OK”) key 306. In the example shown in FIG. 3, the user is assumed to be in a zoo and classifying a photograph of camels. Visual data 13 of symbols S are shown in the display 300. When the desired symbol 308 (actually, its visual data) is located correctly for selection in the display 300, the user presses the selector key 306. There may be a separate key, symbol or user action to indicate that the user is finished with symbol selection. For example, if there is no dedicated key or symbol for that purpose, the user may finish symbol selection by double-clicking the selector key 306. Preferably, the plaintext description 12 may be shown next to the visual data 13.

According to a preferred embodiment of the invention, the symbols S are ordered in a symbol hierarchy, generally denoted by reference numeral 310. The hierarchy resembles a file directory and is self-explanatory to any person with some knowledge in computers, and the hierarchy is preferably user-modifiable.

The part of the hierarchy 310 shown in FIG. 3 has a root 312, two first-level branches 314, 316 and one second-level branch 318. Each branch in the hierarchy 310 comprises an up symbol 320 for navigating to a higher-level branch. Or, the user interface may comprise a key dedicated for that purpose.

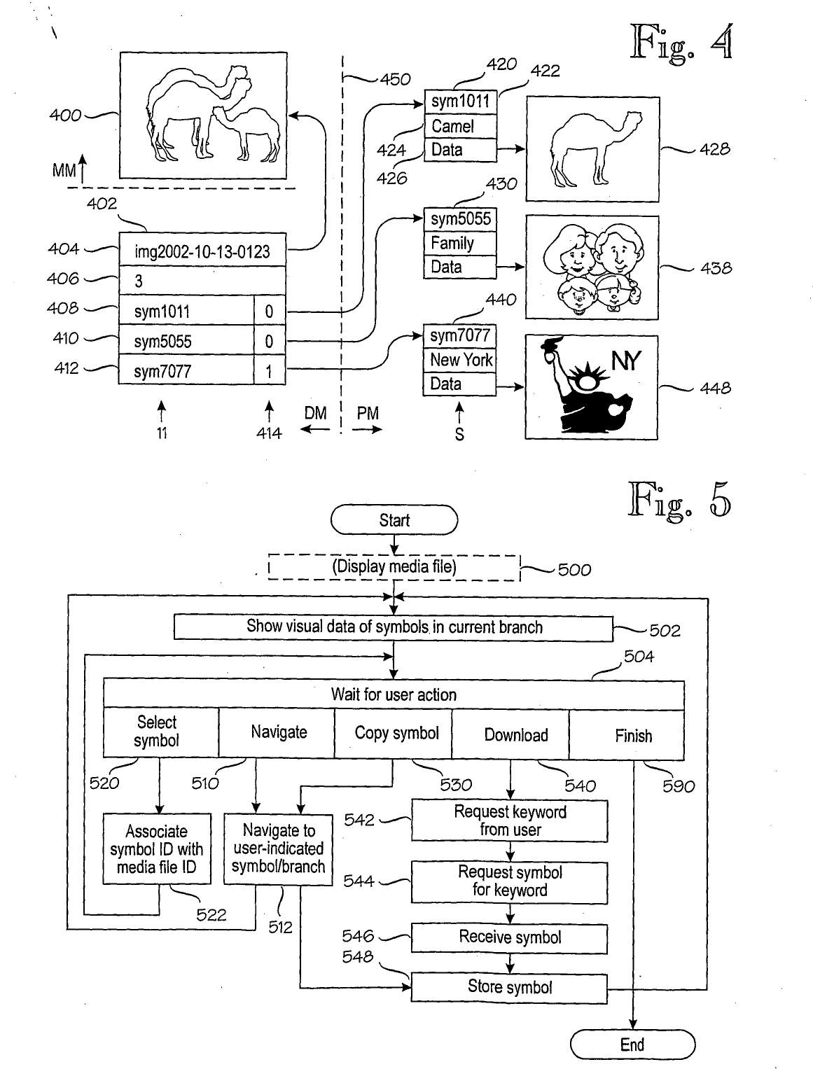

FIG. 4 is a block diagram illustrating memory organization in a storage device. Assume that the user has taken a picture of a camel family in the New York zoo. Reference numeral 400 denotes the photograph. Internally, the photograph is stored as an image file, such as a compressed bitmap, but FIG. 4 shows the visual representation of the photograph. Reference numeral 402 denotes an association data table for the media file (photograph in this example). The association data table 402 comprises the following fields. Field 404 is the file name for the media file. For example, the file name may be purely user-specified, or it may be automatically generated by the device, such as a date and/or a running number. Field 406 is the number of symbols associated with the media file. Fields 408 to 412 indicate the symbol identifiers 11 of the symbols. Field 414 will be described later.

Field 408 links the association data table 402 and the media file 400 to symbol 420 which is a symbol for a camel. The symbol 420 comprises an identifier field 422 and visual data 426. The visual data 426 is used to create a visual presentation 428 of the symbol 420. The plaintext description 424, although shown here, is not absolutely necessary for classification of media files. Similarly, field 410 links the association data table 402 and the media file 400 to symbol 430 which is a symbol for a family.

Finally, field 412 links the association data table 402 to symbol 440 which is a symbol for New York. This is where the optional field 414 can be used to advantage. Field 414 is a symbol visibility flag. Although there is a separate visibility flag for each of the symbols 420, 430 and 440, the visibility flags are denoted by a common reference numeral 414. The visibility flag 414 indicates whether or not the symbol in question will be shown next to the photograph 400 when the user views the photographs. The purpose of the visibility flag 414 is as follows. The photograph 400 has three associated symbols, namely symbols for ‘camel’, ‘family’ and ‘New York’. Each of these symbols will be useful for retrieving the photograph. For example, the user may search for photographs associated with a camel symbol. For picture-searching, all symbols are treated equally. But symbols may also be used to indicate information that is not immediately apparent from a photograph (or other type of media file). In this example, as soon as the user sees the photograph 400, they know that it represents a family of camels. Thus the camel and family symbols are superfluous and would only clutter the display. But the symbol for New York is different because the photograph per se does not indicate that it was taken in the New York zoo.

In this example, the number of symbols associated with the media file 400 was explicitly indicated by field 406, but persons skilled in data tables understand that many other options are available, such as linked lists wherein the last element of the list points to a null element.

Many picture-storage devices, such as digital cameras, are configured to use detachable memory cards. Dashed line 450 is the boundary between the device's permanent memory PM and detachable memory DM. The media files are stored in a section of the detachable memory DM. This section is denoted by reference sign MM (media file memory). An advantage of the memory organization shown in FIG. 4 is that the association of media files and symbols is retained when the detachable memory DM is detached from the device and stored elsewhere. Or, the media file 400 and the association data 402 may be transferred to another device, such as a computer, in which case the media file and the association data can be transferred together. Note that if the media file 400 is stored in a detachable memory card but the association data 402 is not stored in the same card, the field 404 should also indicate an identifier of the media card.

FIG. 5 is a flowchart illustrating a user interface logic related to symbols. The user interface logic is typically implemented by suitable program routines executed by a processor within the data-storage device. In an optional step 500, the media file is displayed. This step is optional because for some media file types, such as music files, the step may not be meaningful. Even with photographs this step is not essential but helps the user to find a suitable collection of symbols. In step 502, the visual data of symbols in the current branch are shown. The meaning of branches was described in connection with FIG. 3. In step 504 the user interface logic waits for user action.

In step 510 the user interface logic detects a user action for navigating to another symbol or branch. The navigation is executed in step 512, as described earlier in connection with FIG. 3. The user interface logic returns to step 504 to wait for the next user action.

In step 520 the user interface logic detects a user action for selecting a symbol. For instance, the user action for selecting a symbol may be a press of selection key 306. In step 522 the symbol identifier 11 of the user-selected symbol is associated with the identifier of the media file, as described earlier in connection with FIG. 4. Steps 512 and 522 are repeated until the user terminates the symbol-association process in step 590.

Routines (steps) 530 to 548 are optional. In step 530 the user interface logic detects a user action for copying a symbol to another branch. The logic executes step 512, in which the user navigates to a desired branch. In step 548 the symbol is stored in its new branch. In addition to a “copy symbol” routine, there may be a “move symbol” routine. The advantage of copying symbols to multiple branches is that frequently-used symbols are easier to locate. For example, a symbol for “myself” may be stored in “family”, “work” and “travels” branches, etc. If a symbol only contains a reference (address) to an external image file, as shown in FIG. 2, the symbol takes up very little space even if it is stored in multiple branches.

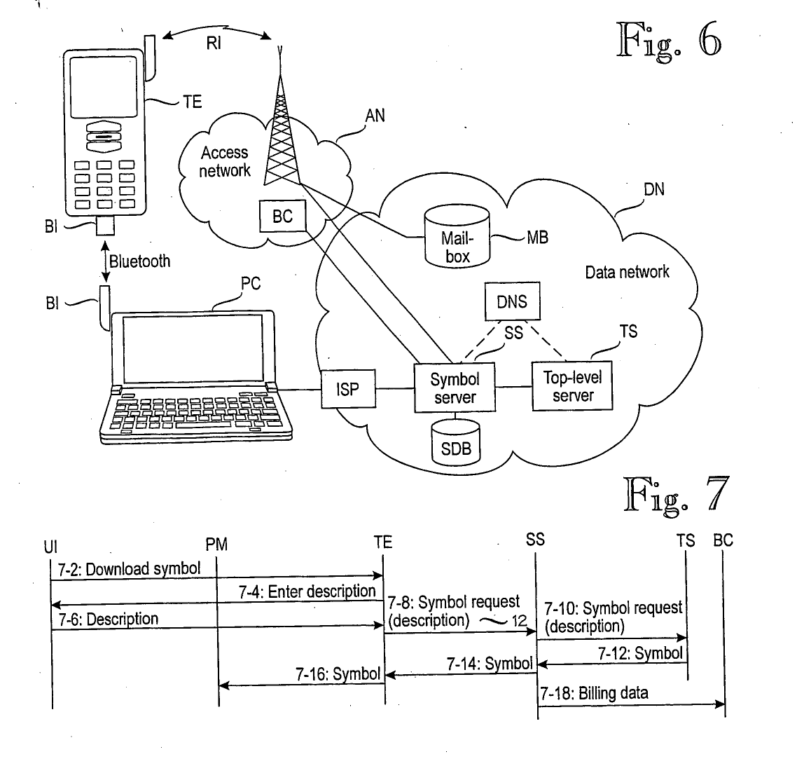

In step 540 the user interface logic detects a user action for downloading (or otherwise obtaining) an extra symbol from an external source, such as a dedicated symbol server. This is where the plaintext description is useful. In step 542 the user interface logic prompts the user for a plaintext description of the desired symbol. For example, the user may have taken a photograph of a zebra but their device does not have a zebra symbol. The user keys in the word “zebra”. If the device in question is or comprises a mobile telephone, its keypad can be used. Even if the device does not have any numeric or alphabetic keypad at all, alphanumeric symbols can be selected, one at a time, by using the navigation and selection keys 302 to 306. In step 544 the device requests the desired symbol from the external source. In step 546 the desired symbol is received from the external source. In step 548 the received symbol is stored in the current branch. Steps 544 to 548 can be implemented in a manner largely analogous to obtaining new logos or ring tones with a mobile telephone. An embodiment for downloading new symbols via a mobile network will be described in connection with FIGS. 6 and 7. Alternatively, new symbols may be obtained from suitably-programmed memory cards, such as the detachable memory card DM shown in FIG. 4.

FIG. 6 shows a network arrangement suitable for downloading symbols from a dedicated symbol server SS. The symbol server SS is connected to a data network DN, such as the Internet or a public switched telephone network (PSTN). The symbol server SS comprises or is connected to a symbol data base SDB for storing a large collection of symbols.

A user terminal TE, such as a mobile telephone, accesses the symbol server SS via a radio interface RI and an access network AN. For example, the access network may be a cellular network. There is also a personal computer PC shown in FIG. 6. The personal computer PC may access the data network DN via an Internet service provider ISP. New symbols may first be downloaded to the personal computer PC. The symbols may then be transferred to the user terminal TE via any suitable interface. FIG. 6 shows a Bluetooth interface BI between the user terminal TE and the personal computer PC, but any data interface can be used, such as a serial connection, infrared link, etc. Moreover, detachable memory cards may be transferred between the user terminal TE and the personal computer PC. FIG. 6 also shows a networked storage, such as an optional mailbox MB to which the terminal user may send their media files, such as photographs or video clips, along with the symbol association data 402, so that the corresponding memory area in the terminal TE can be released. Alternatively, the terminal TE may send the media files and association data to the personal computer PC via any suitable interface, such as the Bluetooth interface BI.

Preferably, the symbol database SDB contains the plaintext description 12 for the symbols S in several human languages. The symbol server SS may then send the symbol with the plaintext description in the user's own language. An advantage achieved by storing the plaintext descriptions in several human languages is that a symbol server SS in one country may serve visiting users in their own languages. The symbol server SS may determine the user's language on the basis of an explicit indication in the symbol request. Alternatively, the symbol server SS may be operated by the operator of the access network AN or the internet service provider ISP, in which case the symbol server SS may determine the user's language on the basis of an inquiry to a subscriber register. As a further alternative, the symbol server SS may be operated on a subscription basis such that the user needs to register with the service, in which case the symbol server knows the user's language on the basis of the registration.

According to another preferred embodiment of the invention, the symbol server SS is part of a network-wide or global hierarchy of symbol servers. FIG. 6 shows an optional top-level server TS. If the symbol server SS does not have a requested symbol, it may contact the another server, such as the top-level server TS. The symbol server SS may obtain network addresses of other servers via a domain name server DNS.

According to yet another preferred embodiment of the invention, the symbol server SS is adapted to send a billing centre BC of the access network AN a billing data record that indicates the number, price and/or type of symbols transferred to the terminal. Thus the network operator may charge the terminal subscriber for the transferred symbols.

FIG. 7 shows a signalling diagram for downloading symbols from a network arrangement as shown in FIG. 6. Reference sign UI denotes the terminal's user interface and PM its permanent memory, that is the memory in which the symbols are stored. Reference sign TE refers to sections of the terminal other than the user interface and the permanent memory.

In step 7-2 the user enters, via the user interface UI, a request to download a specific symbol. In step 74 the terminal TE prompts the user for a description for the symbol. The description corresponds to items 12 and 22 in FIGS. 1 and 2. In step 7-6 the user enters the description. In step 7-8 the terminal TE sends the symbol server SS a request for a symbol corresponding to the user-entered description. Assume that the user has photographed a rare animal for which the local symbol server SS does not have a symbol. In this case the local symbol server SS relays the symbol request to the top-level server TS, which is assumed to have the requested symbol. Or, the top-level server TS may send an inquiry for other symbol servers (this step is not shown separately). In step 7-12 the top-level server sends the requested symbol to the local symbol server SS which relays it to the terminal TE in step 7-14. In step 7-16 the terminal TE stores the symbol in the permanent memory PM. Now the user can continue with symbol association, as disclosed earlier in connection with FIGS. 3 to 5. In an optional step 7-18 the symbol server SS sends the billing centre BC billing data, such as a charging data record, that indicates the number, price and/or type of symbols transferred to the terminal.

For clarity, FIG. 7 shows a scenario in which a single symbol is downloaded in response to a single request. That is, the symbol request 7-8 only indicates a single symbol. As an alternative, the symbol request 7-8 can indicate several symbols, in which case all the requested symbols (or that are all available to the symbol server) are downloaded together. As a yet further alternative, a single symbol request 7-8 may indicate a logical group of symbols that are downloaded together. For instance, a theme group of symbols, such as “zoo animals”, can be downloaded as a group, whereby a symbol does not have to be requested and downloaded for each animal separately. Similarly, at the time of major events, such as the Olympic games or the football World cup, network operators may offer related symbols as groups. Especially with such symbol groups, it is advantageous to download the symbols in compressed form to minimize consumption of telecommunication resources.

If several symbols are to be downloaded at a time, it is beneficial if the downloading takes place at a time when transmission charges are low, which typically means night-time. On the other hand, it may be inconvenient for the terminal user to request symbol downloading at night. Accordingly, it is beneficial if the symbol downloading can be specified to take place at some predetermined point in the future. The point in the future may mean a specific hour, such as after midnight. Alternatively, it may mean any point of time when a specific set of criteria is satisfied. For instance, it is envisioned that future telecommunication networks may use dynamic tariffs, based on current load. The networks broadcast advertising messages that announce the current tariff or special discount. Thus one example of a criterion is that the tariff is below a given threshold. Another example of a criterion is that there is a radio connection to a specified network. For instance, some multi-purpose mobile terminals can be used off-line on airplanes, and the user may specify in advance that a set of symbols relevant to the visited country will be downloaded as soon as a radio connection can be established.

Thus it is beneficial if the terminal can defer sending the download request until a predetermined point of time or until a set of conditions are met. Alternatively, the terminal may specify the set of conditions in the symbol request to the symbol server, in which case the symbol server defers transmission until the set of conditions are met.

In connection with FIG. 1, it was stated that the visual data of symbols should be detailed enough to permit reliable recognition of symbols, but not so detailed as to consume large amounts of resources. Accordingly, the symbol server may store the visual data of symbols in multiple resolutions (or in a resolution-independent vector form), and the visual data of symbols transferred to the terminal is dimensioned according to the size and resolution of the terminal's display.

According to yet another preferred embodiment of the invention, the symbol server is adapted to update existing symbols in the terminal. For instance, such updating may comprise transferring the plaintext description of symbols in one or more new languages.

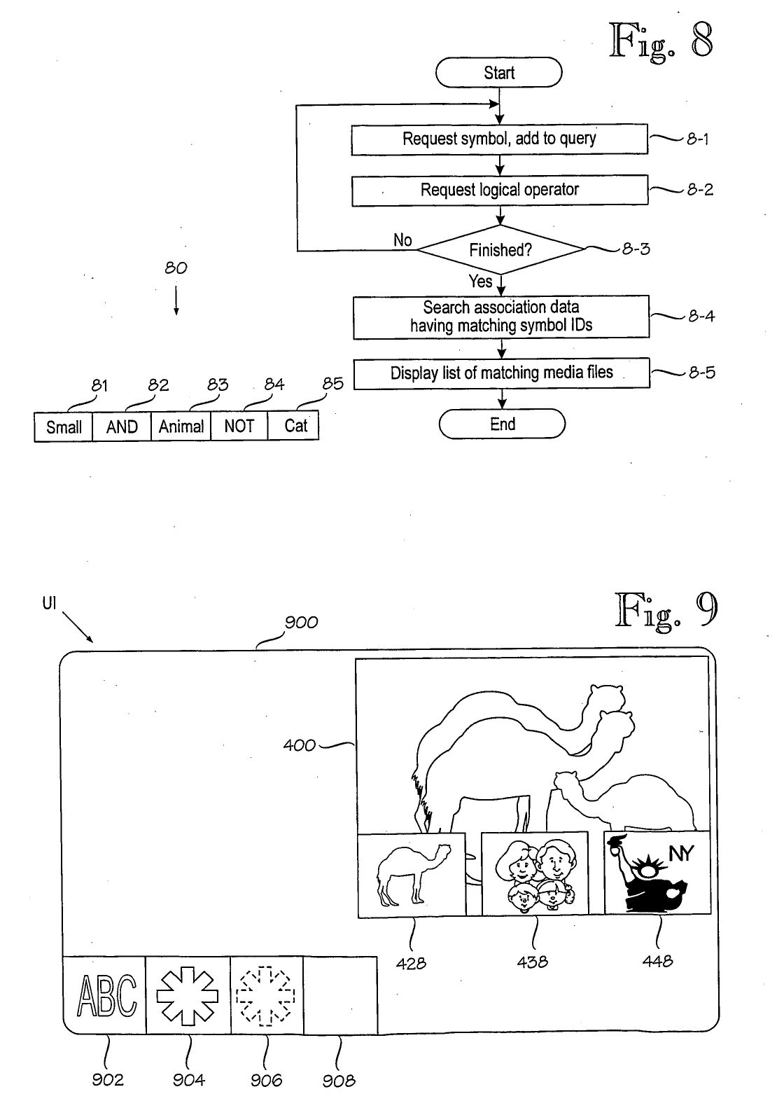

FIG. 8 shows a flowchart for selecting media files based on symbols. The user is prompted for symbols such that the collection of symbols indicate the content of the media files the user is interested in. In step 8-1 the user is prompted for a symbol. In practice, this step can be implemented very similar to the process of associating symbols with a media file, the only difference being that in the selection process the symbol identifiers are not associated with a media file but with a query. However, the step of presenting visual data of symbols to the user and receiving user indication of selected symbols can be similar for both applications.

In an optional step 8-2 the user is prompted for a logical operator, such as AND or OR. The symbol identifiers 11 of the symbols indicated by the user and the optionally requested logical operators are added to the query. Step 8-1 and the optional step 8-2 are repeated until the user indicates that the collection of symbols for the query is complete in step 8-3. For example, the user may enter query parameters like “small AND animal NOT cat”. Such a query could retrieve photographs (or video clips) of small animals other than cats. In step 84 the device searches for association data 402 that meets the search criteria. In step 8-5 the device displays a list of the media files that match the query. If the media files in question are images, the device may actually show the images, instead of their file names. But if the media files are music files or video clips, it is more appropriate to show first a list of the relevant file names.

To provide a concrete example, FIG. 8 also shows a query 80 that consists of elements 81 to 85. Suppose the user wishes to select photographs (or video clips) of small animals other than cats. In the first loop, the user selects the symbol 81 for “small” and the operator 82 for “AND”. In the second loop, the user selects the symbol 83 for “animal” and the operator 0.84 for “NOT”. In the third and last loop, the user selects symbol 85 for “cat” but no further operator. Because no logical operator is entered, the query logic knows that the query is complete, and the process advances to steps 84 and 8-5.

FIG. 9 shows some optional features of an advanced user interface UI. We will re-use the photograph example shown in FIG. 4. The photograph 400, shown in the display 900 of the user interface, presents a family of camels in the New York zoo. Three symbols were associated with the photograph, namely “camel”, “family” and “New York”, as shown by the visual data 428, 438 and 448. The visual data of the associated symbols may be shown in proximity to the photograph 400, for instance superimposed on top of the photograph. As can be seen in FIG. 9, showing the visual data for all associated symbols clutters the user interface UI. Accordingly, a preferred user interface for a storage device comprises means, such as user interface buttons 902 to 908, for selectively displaying the associated symbols. In this example, button 902, labelled “ABC”, means text. Clicking this button causes the plaintext description 12 of the symbols to be displayed, instead of (or in addition to) the visual data 13 of the associated symbols. Button 904 is drawn with a solid line. Clicking this button shows the visual data 428, 438 and 448 of all associated symbols, including symbols for which the visibility indicator 414 is off. Button 906 is drawn with a dashed line. Clicking this button shows the visual data of only the symbols for which the visibility indicator 414 is on. In this example, clicking button 906 would hide the camel and family symbols and show only the symbol for New York. Button 908 is an empty button, which hides all symbols, whereby the photograph 400 is shown with maximum clarity.

As a yet further alternative, there may be a user interface control for displaying the symbols transparently, whereby the underlying image is partially visible through the symbol.

It is readily apparent to a person skilled in the art that, as the technology advances, the inventive concept can be implemented in various ways. The invention and its embodiments are not limited to the examples described above but may vary within the scope of the claims.

1-45. (canceled)

46. A method for storing one of a plurality of media files with an apparatus operable to store media files, the method comprising:
storing in the apparatus a plurality of symbols, wherein each symbol comprises at least a symbol identifier, and visual data;
displaying visual data of at least a subset of the symbols to a user;
receiving an indication of a user-selected symbol;
creating association data indicating association of the user-selected symbol with the media file;
repeating at least the two previous steps until termination by the user; and
transferring to the apparatus one or more symbols in response to a user act.

47. A method for selecting media files with an apparatus operable to store media files, the method comprising:
storing in said apparatus a plurality of media files and a plurality of symbols, wherein each symbol comprises at least a symbol identifier and visual data;
creating an association of each of the plurality of media files with one or more symbol identifiers;
receiving a user selection of symbols, wherein the reception of the user selection comprises:
(a) presenting the visual data of a symbol to the user;
(b) in response to the user selecting the symbol, adding the symbol identifier of the symbol to a set of query parameters;
(c) repeating the two previous steps until termination by the user;
forming a query on the basis of the set of query parameters;
querying the plurality of media files for media files that match the query; and
transferring to the apparatus one or more symbols in response to a user act.

48. A method according to claim 47, wherein the transferring step comprises sending one or more symbol requests to a symbol server and receiving the one or more symbols from the symbol server.

49. A method according to claim 48, wherein the one or more symbol requests comprise a plaintext description for the requested symbol.

50. A method according to claim 48, wherein the symbol server consults another server if it does not have a symbol indicated by the symbol request.

51. A method according to claim 48, further comprising the symbols server sending a billing centre an indication on the number, price and/or type of symbols transferred to the apparatus, whereby the billing centre can charge the subscriber of the apparatus for the transferred symbols.

52. A method according to claim 48, wherein the apparatus and the symbol server communicate via a radio interface.

53. A method according to claim 46, wherein the transferring step comprises transferring the one or more symbols from a detachable memory.

54. A method according to claim 46, wherein the transferring step comprises transferring the one or more symbols via a Bluetooth interface.

55. A method according to claim 46, wherein the transferring step comprises transferring a logical group of symbols.

56. A method according to claim 46, wherein the transferring step takes place when a set of user-specified criteria are met.

57. A method according to claim 46, wherein the transferring step comprises transferring a logical group of symbols in response to a single user act or request.

58. An apparatus for storing media files, the apparatus comprising:
a media file memory area for storing a plurality of media files;
a symbol memory area for storing a plurality of symbols, wherein each symbol comprises at least a symbol identifier and visual data;
a user interface for symbol selection by a user, the user interface comprising:
(a) a display for presenting the contents and/or identifier of a media file and the visual data of at least a subset of the plurality of symbols;
(d) a cursor control for user navigation among the presented visual data and for receiving an indication of one or more user-selected symbols;
a software routine and association data for associating the presented media file with the identifier of each user-selected symbol; and
means for transferring to the apparatus one or more symbols in response to a user act.

59. An apparatus for retrieving one or more media files, the apparatus comprising:
a media file memory area for storing a plurality of media files;
a symbol memory area for storing a plurality of symbols, wherein each symbol comprises at least a symbol identifier, and visual data;
an association data for associating each of the plurality of media files with one or more symbol identifiers;
a user interface for symbol selection by a user, the user interface comprising:
(a) a display for presenting the visual data of at least a subset of the plurality of symbols;
(d) a cursor control for user navigation among the presented visual data and for receiving an indication of one or more user-selected symbols;
a software routine for querying the association data for media files that are associated with the symbol identifiers that correspond to the user-selected symbols; and
means for transferring to the apparatus one or more symbols in response to a user act.

60. An apparatus according to claim 58, wherein the media file memory area and the association data are within the same detachable memory, whereby the association of media files and symbols is retained if the detachable memory is detached from the apparatus.

61. An apparatus according to claim 58, further comprising means for transmitting a media file and the association data of the media file to an external device.

62. An apparatus according to claim 58, further comprising means for requesting and receiving symbols from an external device.

63. An apparatus according to claim 58, wherein each symbol also comprises a flag indicating whether the symbol is user-modifiable.

64. An apparatus according to claim 58, further comprising a symbol hierarchy, the symbol hierarchy having a root and multiple branches.

65. An apparatus according to claim 64, wherein the apparatus is operable to store at least one symbol in multiple branches.

66. An apparatus according to claim 58, wherein the symbol is coded in a mark-up language.

67. An apparatus according to claim 58, wherein the visual data is in a scalable vector graphics format.

68. An apparatus according claim 58, wherein the visual data is a reference to an image file separate from the symbol.

69. An apparatus according to claim 58, wherein the user interface is operable to present the visual data of the symbols associated with a media file in proximity of the contents of the media file.

70. An apparatus according to claim 69, wherein the association data comprises an indicator for individually indicating whether or not the visual data of each symbol associated with a media file is presented in proximity of the contents of the media file.

71. An apparatus according to claim 70, wherein the user interface comprises means for selectively displaying visual data of symbols associated with the media file.

72. An apparatus according claim 58, wherein each symbol also comprises a plaintext description.

73. An apparatus according to claim 72, wherein the user interface is operable to present the plaintext description in response to the user navigating to a symbol.

74. An apparatus according to claim 62, further comprising means for requesting said symbols at a user-specified time.

75. An apparatus according to claim 62, further comprising means for requesting said symbols when a user-specified set of criteria are met.

76. A symbol server for sending one or more symbols to a terminal for storing media files, the symbol server comprising:
a symbol data base for storing a plurality of symbols, wherein each symbol comprises at least a symbol identifier and visual data;
means for receiving a symbol request from the terminal; and
means for sending one or more symbols that match the symbol request to the terminal.

77. A symbol server according to claim 76, wherein each symbol also comprises at least one plaintext description.

78. A symbol server according to claim 76, wherein the symbol request comprises a plaintext description of the symbol indicated by the symbol request and the symbol server is operable to send the terminal one or more symbols that comprise the plaintext description comprised in the symbol request.

79. A symbol server according to claim 77, wherein at least some symbols comprise the plaintext description in several human languages.

80. A symbol server according to claim 76, further comprising means for consulting another server if the symbol server does not contain a symbol matching the symbol request.

81. A symbol server according to claim 76, further comprising means for sending a billing centre an indication on the number, price and/or type of symbols transferred to the terminal.

82. A symbol server according to claim 76, further comprising means for sending the one or more symbols at a time indicated by the symbol request.

83. A symbol server according to claim 76, further comprising means for sending the one or more symbols when a set of criteria indicated by the symbol request are met.

84. A symbol server according to claim 76, further comprising means for updating existing symbols in the terminal.

85. A symbol data set for indicating classification of one or more media files, the symbol data set comprising a plurality of symbols, each symbol comprising at least a symbol identifier, a plaintext description and visual data.

86. A symbol data set according to claim 85, wherein the symbol file is a mark-up language file.

87. A symbol data set according to claim 85, wherein the visual data is contained within the symbol data set as a compact file.

88. A symbol data set according to claim 85, wherein the visual data is a reference to an image file separate from the symbol data set.

89. A symbol data set according to claim 85, wherein the visual data is in a scalable vector graphics format.

90. A symbol data set according to claim 85, further comprising a flag for indicating whether the symbol data set is user-modifiable.
